(19) United States
(12) Patent Application Publication
(10) Pub. No.: US 2024/0396108 A1
(43) Pub. Date: Nov. 28, 2024

(54) PACKAGING MATERIAL FOR FULLY-SOLID-STATE BATTERIES AND FULLY-SOLID-STATE BATTERY INCLUDING THE PACKAGING MATERIAL

(71) Applicant: TOPPAN HOLDINGS INC., Tokyo (JP)

(72) Inventor: Koji MURATA, Tokyo (JP)

(73) Assignee: TOPPAN HOLDINGS INC., Tokyo (JP)

(21) Appl. No.: 18/791,210

(22) Filed: Jul. 31, 2024

Related U.S. Application Data
(63) Continuation of application No. PCT/JP2023/003264, filed on Feb. 1, 2023.

(30) Foreign Application Priority Data
Feb. 7, 2022 (JP) 2022016949

(51) Int. Cl. H01M 10/52; H01M 50/105; H01M 50/121; H01M 50/126; H01M 50/178

(52) U.S. Cl. CPC H01M 10/52; H01M 50/105; H01M 50/121; H01M 50/126; H01M 50/178

(57) ABSTRACT

A packaging material for fully-solid-state batteries, including at least a substrate layer, a gas barrier layer, a sealant layer, and a hydrogen sulfide adsorption layer, in which the hydrogen sulfide adsorption layer contains a modified polyolefin resin and a hydrogen sulfide adsorbent and has a thickness of equal to or more than 0.5 μm and less than 10 μm.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2023/003264, filed on Feb. 1, 2023, which is based upon and claims the benefit to Japanese Patent Application No. 2022-016949 filed on Feb. 7, 2022, the disclosures of all which are incorporated herein by reference in their entirety.

### TECHNICAL FIELD

The present disclosure relates to a packaging material for fully-solid-state batteries and a fully-solid-state battery including the packaging material.

### BACKGROUND

Secondary batteries such as lithium-ion batteries are widely used in portable electronic devices, electric vehicles and hybrid electric vehicles which use electricity as a power source, and others. As batteries having improved safety over lithium-ion batteries, solid-state lithium batteries including an inorganic solid electrolyte in place of an organic solvent electrolyte have been studied. Fully-solid-state lithium batteries have better safety than lithium-ion batteries, in that thermal runaway resulting from a short circuit or the like is unlikely to occur.

Of inorganic solid electrolytes, a sulfide-based solid electrolyte is higher in ionic conductivity than an oxide-based solid electrolyte or others and has multiple advantages in obtaining an all-solid-state battery having higher performance. For example, PTL 1 discloses an all-solid-state battery including a sulfide-based electrolyte powder which contains a sulfur element, a lithium element, and at least one element selected from the group consisting of boron, silicon, germanium, phosphorus, and aluminum and which has a mean particle diameter of 0.01 to 10 μm.
[Citation List] [Patent Literature] [PTL 1] JP 2008-288098 A

### SUMMARY OF THE INVENTION

### Technical Problem

However, in an all-solid-state battery including a sulfide-based solid electrolyte, toxic hydrogen sulfide (H₂S) may be generated due to moisture having penetrated the battery. Therefore, the hydrogen sulfide generated from the sulfide-based solid electrolyte is required to be swiftly removed and is particularly required to be swiftly removed in the interior (on the sulfide-based solid electrolyte side) of a packaging material. Further, the packaging material is required to have, in addition to absorbency to hydrogen sulfide, excellent heat seal strength, from the viewpoint of sealing performance of the package of the all-solid-state battery.

The present disclosure has been made in view of the above-described problems of known technologies, and an object of the present disclosure is to provide: a packaging material for all-solid-state batteries capable of striking a balance between excellent heat seal strength and excellent hydrogen sulfide absorbency; and an all-solid-state battery including the packaging material.

### Solution to Problem

For achieving the above-described object, the present disclosure provides a packaging material for all-solid-state batteries that includes at least a substrate layer, a gas barrier layer, a sealant layer, and a hydrogen sulfide adsorption layer, in which the hydrogen sulfide adsorption layer contains a modified polyolefin resin and a hydrogen sulfide adsorbent and has a thickness of greater than or equal to 0.5 μm and less than 10 μm.

In the packaging material for all-solid-state batteries, the hydrogen sulfide adsorption layer may be disposed on a surface facing toward the gas barrier layer of the sealant layer.

In the packaging material for all-solid-state batteries, the hydrogen sulfide adsorption layer may be disposed on a surface on a surface of the sealant layer that faces the gas barrier layer.

In the packaging material for all-solid-state batteries, the modified polyolefin resin may be an acid-modified polyolefin resin.

The acid-modified polyolefin resin may be a maleic anhydride-modified polypropylene resin.

The acid value of the acid-modified polyolefin resin may be 2 to 30 mgKOH/g.

The melting point of the acid-modified polyolefin resin may be 70 to 150° C.

In the packaging material for all-solid-state batteries, the content of the hydrogen sulfide adsorbent, relative to the total amount of the hydrogen sulfide adsorption layer, may be 1 to 50 mass %.

In the packaging material for all-solid-state batteries, the hydrogen sulfide adsorption layer may further contain at least one selected from the group consisting of an isocyanate compound, a carbodiimide compound, and an oxazoline compound.

In the packaging material for all-solid-state batteries, the hydrogen sulfide adsorption layer may be formed by coating with a coating liquid that contains at least a modified polyolefin resin and a hydrogen sulfide adsorbent.

In the packaging material for all-solid-state batteries, the hydrogen sulfide adsorption layer may have a thickness of less than 5 μm.

The present disclosure also provides an all-solid-state battery including: a battery element that contains a sulfide-based solid electrolyte; a current-extracting terminal extending from the battery element; and the packaging material for all-solid-state batteries according to any one of claims 1 to 10 which sandwiches the current-extracting terminal and houses the battery element.

### Advantageous Effects of the Invention

According to the present disclosure, there can be provided: a packaging material for all-solid-state batteries capable of striking a balance between excellent heat seal strength and excellent hydrogen sulfide absorbency; and an all-solid-state battery including the packaging material.

### BRIEF DESCRIPTION OF THE DRAWINGS

FIG. 1 is a schematic cross-sectional view of a packaging material for all-solid-state batteries according to an embodiment of the present disclosure.

FIG. 2 is a schematic cross-sectional view of a packaging material for all-solid-state batteries according to an embodiment of the present disclosure.

FIG. 3 is a schematic cross-sectional view of a packaging material for all-solid-state batteries according to an embodiment of the present disclosure.

FIG. 4 is a schematic cross-sectional view of a packaging material for all-solid-state batteries according to an embodiment of the present disclosure.

FIG. 5 is a perspective view of an all-solid-state battery according to an embodiment of the present disclosure.

FIG. 6 is a schematic view for explaining a method of preparing a sample for measuring heat seal strength in examples.

### DETAILED DESCRIPTION

Hereinafter, preferred embodiments of the present disclosure will be described in detail with reference to the drawings. In the drawings, the same or equivalent portions are denoted by the same reference signs, and duplicate description is omitted. Further, the dimensional ratios of the drawings are not limited to those as shown.

[Packaging Material for all-Solid-State Batteries]

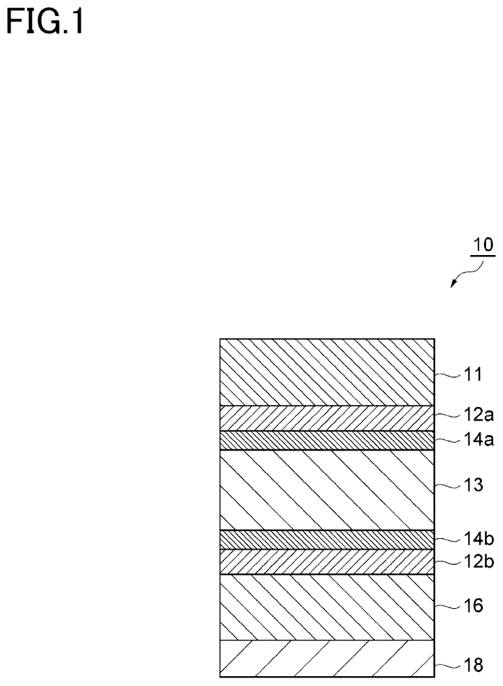

FIG. 1 is a cross-sectional view schematically showing an embodiment of a packaging material for all-solid-state batteries according to the present disclosure. As shown in FIG. 1, a packaging material (packaging material for all-solid-state batteries) 10 of the present embodiment is a laminate of a substrate layer 11, a first adhesive layer 12a disposed on one surface of the substrate layer 11, a gas barrier layer 13 that has first and second anti-corrosion treatment layers 14a and 14b on opposing surfaces thereof and faces the substrate layer via the first adhesive layer 12a, a second adhesive layer 12b disposed on a surface of the gas barrier layer 13 opposite to that facing the first adhesive layer 12a, a sealant layer 16 disposed facing the gas barrier layer 13 via the second adhesive layer 12b, and a hydrogen sulfide adsorption layer 18 disposed facing the gas barrier layer 13 via the sealant layer 16. Here, the first anti-corrosion treatment layer 14a is disposed on a surface at the substrate layer 11 side of the gas barrier layer 13, and the second anti-corrosion treatment layer 14b is disposed on a surface at the sealant layer 16 side of the gas barrier layer 13. In the packaging material 10, the substrate layer 11 is the outermost layer, and the hydrogen sulfide adsorption layer 18 is the innermost layer. That is, the packaging material 10 is used with the substrate layer 11 facing outside an all-solid-state battery and the hydrogen sulfide adsorption layer 18 facing inside an all-solid-state battery. Hereinafter, the layers constituting the packaging material 10 will be specifically described.

### <Substrate Layer 11>

The substrate layer 11 serves to impart heat resistance in the sealing step during production of an all-solid-state battery and suppress occurrence of pinholes that may occur during molding or distribution. Particularly for a packaging material of all-solid-state batteries used in large applications, scratch resistance, chemical resistance, insulation properties, and the like can also be imparted.

The substrate layer 11 is preferably a layer formed of a resin having insulation properties. Examples of the usable resin include a polyester resin, a polyamide resin, a polyimide resin, a polyamideimide resin, a polyetherketone resin, a polyphenylene sulfide resin, a polyether imide resin, a polysulfone resin, a fluorine resin, a phenol resin, a melamine resin, a urethane resin, an allyl resin, a silicon resin, an epoxy resin, a furan resin, and an acetyl cellulose resin.

These resins, when used in the substrate layer 11, may be in a stretched or unstretched film form or may be in the form of a coating film. Further. The substrate layer 11 may be either a single layer or a multilayer. When the substrate layer 11 is a multilayer, the substrate layer 11 may be formed by combining different resins. When the substrate layer 11 is a film, it may be obtained by co-extrusion or by lamination via an adhesive. When the substrate layer 11 is a coating film, it may be obtained by coating a number of times corresponding to the number of laminations, or a film and a coating film may be combined to obtain a multilayer.

Among these resins, a polyester resin or a polyamide resin, which are excellent in molding properties, are preferable as the substrate layer 11. Examples of the polyester resin include polyethylene terephthalate, polybutylene terephthalate, and polyethylene naphthalate. Examples of the polyamide resin constituting a polyamide film include Nylon-6, Nylon-6,6, a copolymer of Nylon-6 and Nylon-6,6, Nylon-6, Nylon-9T, Nylon-10, polymetaxylylene adipamide (MXD6), Nylon-11, and Nylon-12.

When these resins are used in a film form, a biaxially stretched film is preferable. Examples of a stretching method used for the biaxially stretched film include sequential biaxial stretching, tubular biaxial stretching, and simultaneous biaxial stretching. From the viewpoint of obtaining more excellent deep drawing properties, the biaxially stretched film is preferably stretched by tubular biaxial stretching.

The substrate layer 11 preferably has a thickness of 6 to 40 μm and more preferably 10 to 30 μm. When the substrate layer 11 has a thickness of 6 μm or more, the packaging material 10 tends to have improved pinhole resistance and insulation properties. When the substrate layer 11 has a thickness exceeding 40 μm or less, the total thickness of the packaging material 10 tends to increase.

The melting point peak temperature of the substrate layer 11 may be higher than the melting point peak temperature of the sealant layer 16 and is preferably higher by 30° C. or more than the melting point peak temperature of the sealant layer 16, in order to suppress deformation of the substrate layer 11 during sealing.

<First Adhesive Layer 12a>

The first adhesive layer 12a is a layer for bonding the substrate layer 11 and the gas barrier layer 13. An example of the material constituting the first adhesive layer 12a is a polyurethane resin obtained by allowing an isocyanate compound having two or more functional groups (a polyfunctional isocyanate compound) to act on a base resin such as a polyester polyol, a polyether polyol, an acrylic polyol, or a carbonate polyol. The above-described various polyols can be used individually or in combination of two or more, depending on the function and performance required of the packaging material 10. Another example is, but is not limited to, a product obtained by formulating a curing agent in an epoxy resin as a base resin. Further, other various additives and a stabilizer may be formulated to the above-described adhesives, depending on the performance required of the adhesive.

The thickness of the first adhesive layer 12a is not particularly limited, but is, for example, preferably 1 to 10 μm and more preferably 2 to 7 μm, from the viewpoint of obtaining desired adhesion strength, followability, processability, and the like.

### <Gas Barrier Layer 13>

The gas barrier layer 13 has water vapor barrier properties to prevent moisture from penetrating to the inside of an all-solid-state battery. Further, the gas barrier layer 13 may have ductility for performing deep drawing. Examples of the usable gas barrier layer 13 include various metal foils such as aluminum, stainless steel, and copper, or a metal vapor deposited film, an inorganic oxide vapor deposited film, a carbon-containing inorganic oxide vapor deposited film, and films provided with these vapor deposited films. Examples of the usable films provided with the vapor deposited films include an aluminum vapor deposited film and an inorganic oxide vapor deposited film. These can be used individually or in combination of two or more. The gas barrier layer 13 is preferably a metal foil and more preferably an aluminum foil, in view of mass (specific gravity), moisture resistance, processability, and cost.

A preferable aluminum foil is particularly an annealed soft aluminum foil, in view of imparting desired ductility during molding. A more preferable aluminum foil is an iron-containing aluminum foil for a purpose of imparting further pinhole resistance and ductility during molding. The iron content in the aluminum foil, relative to 100 mass % of the aluminum foil, is preferably 0.1 to 9.0 mass % and more preferably 0.5 to 2.0 mass %. When the iron content is 0.1 mass % or more, a packaging material 10 having more excellent pinhole resistance and ductility can be obtained. When the iron content is 9.0 mass % or less, a packaging material 10 having more excellent flexibility can be obtained. An untreated aluminum foil can be used as the aluminum foil, but an aluminum foil subjected to a degreasing treatment is preferable in view of imparting corrosion resistance. When a degreasing treatment is performed to the aluminum foil, the degreasing treatment may be performed to only one surface or both surfaces of the aluminum foil.

The thickness of the gas barrier layer 13 is not particularly limited, but is preferably 9 to 200 μm and more preferably 15 to 100 μm, in consideration of barrier properties, pinhole resistance and processability.

<First and Second Anti-Corrosion Treatment Layers 14a and 14b>

The first and second anti-corrosion treatment layers 14a and 14b are each a layer disposed on a surface of the gas barrier layer 13 in order to prevent corrosion of the metal foil (metal foil layer) or the like constituting the gas barrier layer 13. Further, the first anti-corrosion treatment layer 14a serves to enhance adhesion between the gas barrier layer 13 and the first adhesive layer 12a. Further, the second anti-corrosion treatment layer 14b serves to enhance adhesion between the gas barrier layer 13 and the second adhesive layer 12b. The first anti-corrosion treatment layer 14a and the second anti-corrosion treatment layer 14b may be either layers having the same configurations or layers having different configurations. The first and second anti-corrosion treatment layers 14a and 14b (hereinafter, also merely referred to as the “anti-corrosion treatment layers 14a and 14b”) may be formed by, for example, a degreasing treatment, a hydrothermal modification treatment, an anodic oxidation treatment, a chemical conversion treatment, or a combination of these treatments.

Examples of the degreasing treatment include acid degreasing and alkaline degreasing. Examples of acid degreasing include methods using one or a mixture solution of inorganic acids such as sulfuric acid, nitric acid, hydrochloric acid, and hydrofluoric acid. Further, the use, as the acid degreasing, of an acid degreasing agent obtained by dissolving a fluorine-containing compound such as monosodium ammonium difluoride with the above-described inorganic acid is effective in terms of corrosion resistance, particularly when an aluminum foil is used for the gas barrier layer 13, because not only the effect of degreasing aluminum is obtained, but also a fluoride of aluminum in a passive state can be formed. An example of alkaline degreasing is a method using sodium hydroxide or the like.

An example of hydrothermal modification treatment is a boehmite treatment of immersion-treating an aluminum foil in boiling water to which triethanolamine has been added. An example of anodic oxidation treatment is an alumite treatment.

Examples of chemical conversion treatment include an immersion-type chemical conversion treatment and a coating-type chemical conversion treatment. Examples of immersion-type chemical conversion treatment include various chemical conversion treatments such as a chromate treatment, a zirconium treatment, a titanium treatment, a vanadium treatment, a molybdenum treatment, a calcium phosphate treatment, a strontium hydroxide treatment, a cerium treatment, a ruthenium treatment, and a mixed phase thereof. On the other hand, an example of a coating-type chemical conversion treatment is a method of coating the gas barrier layer 13 with a coating agent having anti-corrosion performance.

When any one of the hydrothermal modification treatment, the anodic oxidation treatment, and the chemical conversion treatment, among the above-described anti-corrosion treatments, is used to form at least a part of the anti-corrosion treatment layer, the above-described degreasing treatment is preferably performed in advance. Note that when a degreased metal foil, such as an annealed metal foil, is used as the gas barrier layer 13, the degreasing treatment may not be performed again in forming the anti-corrosion treatment layers 14a and 14b.

The coating agent used for the coating-type chemical conversion treatment preferably contains trivalent chromium. Further, the coating agent may contain at least one polymer selected from the group consisting of a cationic polymer and an anionic polymer described later.

Particularly in the hydrothermal modification treatment and the anodic oxidation treatment among the above-described treatments, the surface of an aluminum foil is dissolved with a treatment agent to form an aluminum compound (boehmite or alumite) having good corrosion resistance. Therefore, the above-described treatments, in which a co-continuous structure extending from the gas barrier layer 13 including an aluminum foil to the anti-corrosion treatment layers 14a and 14b is formed, are encompassed by the definition of a chemical conversion treatment. On the other hand, the anti-corrosion treatment layers 14a and 14b can also be formed only by a simple coating method which is not encompassed by the definition of a chemical conversion treatment as described later. An example of this method is a method of using a sol of a rare earth element-based oxide such as cerium oxide with a mean particle diameter of 100 nm or less, as a material that has an anti-corrosion effect (inhibitor effect) for aluminum and is environmentally suitable. Use of this method can impart an anti-corrosion effect to a metal foil such as an aluminum foil, even when an ordinary coating method is used.

Examples of the sol of a rare earth element-based oxide include sols that contain various solvents based on water, alcohols, hydrocarbons, ketones, esters, ethers, and the like. The sol of a rare earth element-based oxide is preferably a water-based sol.

The sol of a rare earth element-based oxide usually contains, as a dispersion stabilizer, an inorganic acid such as nitric acid, hydrochloric acid, or phosphoric acid, or a salt thereof, and an organic acid such as acetic acid, malic acid, ascorbic acid, or lactic acid, for stabilizing the dispersion of the sol. Of these dispersion stabilizers, phosphoric acid, in particular, is expected to provide the packaging material 10 with features of, for example, (1) stabilizing dispersion of the sol, (2) improving adhesiveness with the gas barrier layer 13 taking advantage of an aluminum chelation ability of phosphoric acid, (3) imparting corrosion resistance by trapping aluminum ions (forming a passive state), and (4) improving cohesive forces of the anti-corrosion treatment layers (oxide layers) 14a and 14b based on the fact that dehydration condensation of phosphoric acid is likely to occur even at low temperature.

Since the anti-corrosion treatment layers 14a and 14b formed with the sol of a rare earth element-based oxide are aggregates of inorganic particles, the cohesive forces of the layers themselves may be lowered even after the step of dry curing. Therefore, the anti-corrosion treatment layers 14a and 14b in this case are preferably compounded with an anionic polymer or a cationic polymer in order to supplement the cohesive forces.

The anti-corrosion treatment layers 14a and 14b are not limited to the previously-described layers. For example, the anti-corrosion treatment layers 14a and 14b may be formed with a treatment agent obtained by adding phosphoric acid and a chromium compound to a resin binder (such as an aminophenol type), like a coating-type chromate of a known art. With this treatment agent, a layer having both an anti-corrosion function and adhesiveness can be obtained. Further, although the stability of a coating liquid needs to be taken into consideration, a layer having both an anti-corrosion function and adhesiveness can be obtained with a previously prepared one-component coating agent which contains a sol of a rare earth element-based oxide and a polycationic polymer or a polyanionic polymer.

The mass per unit area of the anti-corrosion treatment layers 14a and 14b, whether a multi-layer structure or a single-layer structure, is preferably 0.005 to 0.200 g/m² and more preferably 0.010 to 0.100 g/m². When the mass per unit area is 0.005 g/m² or more, an anti-corrosion function is likely to be imparted to the gas barrier layer 13. Further, even if the mass per unit area exceeds 0.200 g/m², there is little change in the anti-corrosion function. On the other hand, when a sol of a rare earth element-based oxide is used, and the coating film is thick, heat-curing during drying may be insufficient, leading to deterioration in the cohesive forces. Note that the thickness of each of the anti-corrosion treatment layers 14a and 14b can be converted from the specific gravity.

From the viewpoint of facilitating the maintained adhesiveness between the sealant layer 16 and the gas barrier layer 13, an aspect of the anti-corrosion treatment layers 14a and 14b, for example, may contain cerium oxide, 1 to 100 parts by mass of phosphoric acid or phosphate relative to 100 parts by mass of the cerium oxide, and a cationic polymer, may be formed by performing a chemical conversion treatment to the gas barrier layer 13, or may be formed by performing a chemical conversion treatment to the gas barrier layer 13 and contain a cationic polymer.

<Second Adhesive Layer 12b>

The second adhesive layer 12b is a layer for bonding the gas barrier layer 13 and the sealant layer 16. A general-purpose adhesive for bonding the gas barrier layer 13 and the sealant layer 16 can be used for the second adhesive layer 12b.

When the anti-corrosion treatment layer 14b is disposed on the gas barrier layer 13, and the second anti-corrosion treatment layer 14b has a layer that contains the above-described at least one polymer selected from the group consisting of a cationic polymer and an anionic polymer, the second adhesive layer 12b is preferably a layer that contains a compound (hereinafter, also referred to as a “reactive compound”) having reactivity with the above-described polymer contained in the second anti-corrosion treatment layer 14b.

For example, when the second anti-corrosion treatment layer 14b contains a cationic polymer, the second adhesive layer 12b preferably contains a compound having reactivity with a cationic polymer. When the second anti-corrosion treatment layer 14b contains an anionic polymer, the second adhesive layer 12b preferably contains a compound having reactivity with an anionic polymer. Further, when the second anti-corrosion treatment layer 14b contains a cationic polymer and an anionic polymer, the second adhesive layer 12b preferably contains a compound having reactivity with a cationic polymer and a compound having reactivity with an anionic polymer. However, the second adhesive layer 12b does not necessarily need to contain the above-described two types of compounds and may contain a compound having reactivity with both a cationic polymer and an anionic polymer. As described herein, the expression “having reactivity with” refers to forming a covalent bond with a cationic polymer or an anionic polymer. Further, the second adhesive layer 12b may further contain an acid-modified polyolefin resin.

An example of the compound having reactivity with a cationic polymer is at least one compound selected from the group consisting of a polyfunctional isocyanate compound, a glycidyl compound, a compound having a carboxy group, and an oxazoline compound.

Examples of the polyfunctional isocyanate compound include: diisocyanates such as tolylene diisocyanate, xylylene diisocyanate or a hydrogenated product thereof, hexamethylene diisocyanate, 4,4′-diphenylmethane diisocyanate or a hydrogenated product thereof, and isophorone diisocyanate; polyisiocyanates such as adducts obtained by reacting these isocyanates with a polyhydric alcohol such as trimethylolpropane, biurets obtained by allowing them to react with water, and isocyanurates as trimers; or blocked polyisocyanates obtained by blocking these polyisocyanates with alcohols, lactams, oximes, and the like.

Examples of the glycidyl compound include epoxy compounds obtained by allowing epichlorohydrin to act on glycols such as ethylene glycol, diethylene glycol, triethylene glycol, polyethylene glycol, propylene glycol, dipropylene glycol, tripropylene glycol, polypropylene glycol, 1,4-butanediol, 1,6-hexanediol, and neopentyl glycol; epoxy compounds obtained by allowing epichlorohydrin to act on polyhydric alcohols such as glycerin, polyglycerin, trimethylolpropane, pentaerythritol, and sorbitol; and epoxy compounds obtained by allowing epichlorohydrin to act on dicarboxylic acids such as phthalic acid, terephthalic acid, oxalic acid, and adipic acid.

Examples of compounds having a carboxyl group include an aliphatic carboxylic compound, an aromatic dicarboxylic compound, and salts thereof. Further, poly(meth)acrylic acid or an alkali (earth) metal salt of poly(meth)acrylic acid may be used.

An example of the oxazoline compound is a low molecular weight compound having two or more oxazoline units. When a polymerizable monomer such as isopropenyloxazoline is used, examples of the oxazoline compound include compounds obtained by copolymerizing acrylic monomers such as (meth)acrylic acid, (meth)acrylic acid alkyl ester, or hydroxyalkyl (meth)acrylate.

Of these compounds, the compound having reactivity with a cationic polymer is preferably a polyfunctional isocyanate compound in terms of having high reactivity with a cationic polymer and easily forming a crosslinked structure.

An example of the compound having reactivity with an anionic polymer is at least one compound selected from the group consisting of a glycidyl compound and an oxazoline compound. Examples of the glycidyl compound and the oxazoline compound include glycidyl compounds, oxazoline compounds, and the like which have been described above as examples of a crosslinking agent used for forming a crosslinked structure of a cationic polymer. Of these compounds, the compound having reactivity with an anionic polymer is preferably a glycidyl compound in terms of having high reactivity with an anionic polymer.

When the second adhesive layer 12b contains an acid-modified polyolefin resin, the reactive compound preferably also has reactivity with the acid group in the acid-modified polyolefin resin (that is, forms a covalent bond with the acid group). This further enhances adhesion with the second anti-corrosion treatment layer 14b. In addition, the acid-modified polyolefin resin forms a crosslinked structure, which further improves the solvent resistance of the packaging material 10.

The content of the reactive compound, relative to the acid group in the acid-modified polyolefin resin, is preferably 1 to 10 equivalents. When not less than 1 equivalent, the reactive compound sufficiently reacts with the acid group in the acid-modified polyolefin resin. On the other hand, when it exceeds 10 equivalents, the crosslinking reaction with the acid-modified polyolefin resin has been already sufficiently saturated, and therefore unreacted product remains, which raises the concern that various performances may deteriorate. Therefore, for example, the content of the reactive compound, relative to 100 parts by mass of the acid-modified polyolefin resin, is preferably 5 to 20 parts by mass (solid content ratio).

The acid-modified polyolefin resin is obtained by introducing an acid group into a polyolefin resin. Examples of the acid group include a carboxy group, a sulfonic acid group, and an acid anhydride group, and a maleic anhydride group and a (meth)acrylic acid group are particularly preferable. An example of the usable acid-modified polyolefin resin is an acid-modified polyolefin resin similar to the modified polyolefin resin used for the sealant layer 16.

The second adhesive layer 12b may contain various additives such as a flame retardant, a slip agent, an antiblocking agent, an antioxidant, a light stabilizer, and a tackifier.

From the viewpoint of suppressing deterioration in lamination strength, associated with corrosive gas, such as hydrogen sulfide, and an electrolyte and from the viewpoint of further suppressing deterioration in insulation properties, the second adhesive layer 12b may contain, for example, an acid-modified polyolefin and at least one curing agent selected from the group consisting of a polyfunctional isocyanate compound, a glycidyl compound, a compound having a carboxy group, an oxazoline compound, and a carbodiimide compound. Note that examples of the carbodiimide compound include N,N′-di-o-tolylcarbodiimide, N,N′-diphenylcarbodiimide, N,N′-di-2,6-dimethylphenylcarbodiimide, N,N′-bis(2,6-diisopropylphenyl) carbodiimide, N,N′-dioctyldecylcarbodiimide, N-tolyl-N′-cyclohexylcarbodiimide, N,N′-di-2,2-di-t-butylphenylcarbodiimide, N-triyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, and N,N′-di-p-tolylcarbodiimide.

As an adhesive for forming the second adhesive layer 12b, a polyurethane-based adhesive obtained by formulating polyisocyanate and a polyester polyol that includes a hydrogenated dimer fatty acid and a diol, for example, can also be used. Examples of the adhesive include a polyurethane resin obtained by allowing an isocyanate compound having two or more functional groups to act on a base resin such as polyester polyol, polyether polyol, acrylic polyol, or carbonate polyol and an epoxy resin obtained by allowing an amine compound or the like to act on a base resin having an epoxy resin. From the viewpoint of heat resistance, the adhesive is preferably at least one selected from the group consisting of a polyurethane resin obtained by allowing an isocyanate compound having two or more functional groups to act on a base resin such as polyester polyol, polyether polyol, acrylic polyol, or carbonate polyol, and an epoxy resin obtained by allowing an amine compound or the like to act on a base resin having an epoxy resin.

The thickness of the second adhesive layer 12b is not particularly limited, but is preferably 1 to 10 μm and more preferably 2 to 7 μm from the viewpoint of obtaining desired adhesion strength, processability, and the like.

### <Sealant Layer 16>

The sealant layer 16 is a layer that provides the packaging material 10 with sealing properties by heat sealing and is a layer that is heat sealed (thermally fused) during assembly of an all-solid-state battery.

Examples of the sealant layer 16 include a thermoplastic resin such as a polyolefin-based resin, a polyamide-based resin, a polyester-based resin, a polycarbonate-based resin, a polyphenylene ether-based resin, a polyacetal-based resin, a polystyrene-based resin, a polyvinyl chloride-based resin, or a polyvinyl acetate-based resin. From the viewpoint of heat resistance and sealing suitability, one selected from the group consisting of a polyolefin-based resin, a polyamide-based resin, and a polyester-based resin is preferably used as a resin (hereinafter, also referred to as a “base resin”) constituting the sealant layer 16. The above-described various resins may be used individually or in combination of two or more. The above-described various resins can be blended and polymer-alloyed to control sealing appropriateness and heat resistance. The sealant layer 16 may be directly laminated to the gas barrier layer 13 without an adhesive interposed. When the sealant layer 16 is directly laminated to the gas barrier layer 13 without an adhesive interposed, at least a layer in contact with the gas barrier layer 13 preferably contains a compound modified with, for example, an acid or a compound having a glycidyl group.

Examples of the polyolefin-based resin include: low-, medium- or high-density polyethylene; an ethylene-α-olefin copolymer; polypropylene; a block or random copolymer containing propylene as a copolymerization component; and a propylene-α-olefin copolymer. When the polyolefin-based resin is a copolymer, it may be a block copolymer or may be a random copolymer.

Examples of the polyester-based resin include a polyethylene terephthalate (PET) resin, a polybutylene terephthalate (PBT) resin, a polyethylene naphthalate (PEN) resin, a polybutylene naphthalate (PBN) resin, and a copolymer thereof. The polyester-based resin may be obtained by copolymerizing an optional acid and glycol.

The sealant layer 16 may contain a polyolefin-based elastomer. The polyolefin-based elastomer may or may not have compatibility with the above-described base resin or may contain both a compatible polyolefin-based elastomer having compatibility and an incompatible polyolefin-based elastomer having no compatibility. The expression “having compatibility (compatible)” refers to dispersion in the base resin with a dispersion phase size of not less than 1 nm and less than 500 nm. The expression “having no compatibility (incompatible)” refers to dispersing in the base resin with a dispersion phase size of not less than 500 nm and less than 20 μm.

When the base resin is a polypropylene-based resin, an example of the compatible polyolefin-based elastomer is a propylene-butene-1 random copolymer, and an example of the incompatible polyolefin-based elastomer is an ethylene-butene-1 random copolymer. The polyolefin-based elastomers can be used individually or in combination of two or more.

Further, the sealant layer 16 may contain, for example, an antioxidant, a slip agent, a flame retardant, an antiblocking agent, a light stabilizer, a dehydrator, a tackifier, a crystal nucleating agent, and a plasticizer as additives in order to impart seal properties, heat resistance, and other functionalities. The contents of these additives are preferably not more than 5 parts by mass when the total mass of the sealant layer 16 is 100 parts by mass.

Although the sealant layer 16 may contain a hydrogen sulfide adsorbent, it may not contain a hydrogen sulfide adsorbent, from the viewpoint of easily obtaining excellent heat seal strength. The content of the hydrogen sulfide adsorbent in the sealant layer 16 may be 0 to 50 mass %, 0 to 20 mass %, or 0 mass % relative to the total amount of the sealant layer 16, from the viewpoint of easily obtaining excellent heat seal strength.

The sealant layer 16 may be either a single-layer film or a multi-layer film, which is selected depending on required functions. When the sealant layer has a multi-layer configuration, the layers may be laminated to each other by co-extrusion or may be laminated by dry lamination. When the sealant layer has a multi-layer configuration, it is preferable to use the same resin for the layers, from the viewpoint of interlayer adhesiveness. For example, a layer containing a modified polyolefin-based resin as a layer in contact with the gas barrier layer 13 and one layer or multiple layers of a polyolefin-based resin disposed to other layers may be co-extruded and laminated.

The peak melting temperature of the sealant layer varies depending on its application. However, in the case of the packaging material for all-solid-state batteries, it is preferably 160 to 280° C., as this improves heat resistance.

The thickness of the sealant layer 16 is not particularly limited, but is preferably 10 to 100 μm and more preferably 20 to 60 μm, from the viewpoint of striking a balance between the thinning of a film and the improvement of heat seal strength under a high temperature environment. A sealant layer 16 with a thickness of 10 μm or more can have sufficient heat seal strength. A sealant layer 16 with a thickness of 100 μm or less can reduce the amount of water vapor penetrating from the edges of the packaging material. When the sealant layers 16 is a plurality of layers, the total thickness of the plurality of the sealant layers 16 may be in the above-described range, or the thickness of each of the plurality of the sealant layers 16 may be in the above-described range.

### <Hydrogen Sulfide Adsorption Layer 18>

The hydrogen sulfide adsorption layer 18 is a layer that adsorbs hydrogen sulfide generated from a solid electrolyte (for example, a sulfide-based solid electrolyte) of an all-solid-state battery and prevents a leakage of hydrogen sulfide from an all-solid-state battery. The hydrogen sulfide adsorption layer 18 contains at least a modified polyolefin resin and a hydrogen sulfide adsorbent. The hydrogen sulfide adsorption layer 18 may be a layer that provides the packaging material 10 with sealing properties by heat sealing. In the packaging material 10 shown in FIG. 1, the hydrogen sulfide adsorption layer 18 is disposed on the inner side and heat sealed (thermally fused) together with the sealant layer 16 during assembly of an all-solid-state battery. The hydrogen sulfide adsorption layer 18 may be either a single layer or a plurality of layers. As in the packaging material 10 shown in FIG. 1, the hydrogen sulfide adsorption layer 18 may be disposed on a surface opposite the gas barrier layer 13 of the sealant layer 16.

Since existence of another layer on the sealant layer deteriorates heat seal performance, a known packaging material was designed such that the sealant layer is the outermost layer. Although it is possible to form a heat-sealable layer on the sealant layer by forming a layer with a coating liquid that contains a polyolefin resin, no consideration has been given to forming another layer on the sealant layer, because cost increases. However, forming the hydrogen sulfide adsorption layer 18 on the sealant layer 16 is very effective from the viewpoint of obtaining excellent hydrogen sulfide absorbency. Further, since the hydrogen sulfide adsorption layer 18 contains a modified polyolefin resin, excellent heat seal properties can be imparted even when the hydrogen sulfide adsorption layer 18 is provided on the sealant layer 16.

Further, consideration has been also given to containing a hydrogen sulfide adsorbent in the sealant layer itself. In that case, only a hydrogen sulfide adsorbent present near a surface on the battery interior side of a thick sealant layer contributes to adsorption of hydrogen sulfide, and a hydrogen sulfide adsorbent present in a position further from the surface hardly contributes to adsorption of hydrogen sulfide. In contrast, the packaging material of the present embodiment is configured that a thin hydrogen sulfide adsorption layer as a layer different from the sealant layer is disposed on the surface so that the entirety of the hydrogen sulfide adsorbent contained in the layer contributes to adsorption of hydrogen sulfide, and excellent hydrogen sulfide absorbency can be efficiently obtained.

The modified polyolefin resin may be a resin obtained by graft-modifying a polyolefin resin with an unsaturated carboxylic acid derivative component derived from any of an unsaturated carboxylic acid, an acid anhydride of an unsaturated carboxylic acid, and an ester of an unsaturated carboxylic acid or may be an acid-modified polyolefin resin.

Examples of the polyolefin resin include low-density polyethylene, medium-density polyethylene, high-density polyethylene, an ethylene-α-olefin copolymer, homopolypropylene, block polypropylene, random polypropylene, and a propylene-α-olefin copolymer.

Examples of the unsaturated carboxylic acid include acrylic acid, methacrylic acid, maleic acid, fumaric acid, itaconic acid, citraconic acid, tetrahydrophthalic acid, and bicyclo[2,2,1]hepto-2-ene-5,6-dicarboxylic acid.

Examples of the acid anhydride of the unsaturated carboxylic acid include maleic anhydride, itaconic anhydride, citraconic anhydride, tetrahydrophthalic anhydride, and bicyclo[2,2,1]hepto-2-ene-5,6-dicarboxylic anhydride.

Examples of the ester of the unsaturated carboxylic acid include methyl acrylate, methyl methacrylate, ethyl methacrylate, butyl methacrylate, dimethyl maleate, monomethyl maleate, diethyl fumarate, dimethyl itaconate, diethyl citraconate, dimethyl tetrahydrophthalic anhydride, and dimethyl bicyclo[2,2,1]hept-2-ene-5,6-dicarboxylate.

The acid-modified polyolefin resin may be a maleic anhydride-modified polyolefin resin modified with maleic anhydride, and may be a maleic anhydride-modified polypropylene resin from the viewpoint of adhesiveness with the sealant layer 16 and heat resistance. Examples of suitable acid-modified polyolefin resins include “Admer” manufactured by Mitsubishi Chemical Corporation, “Modic” manufactured by Mitsubishi Chemical Corp., “Hardlen” manufactured by Toyobo Co., Ltd., and “Auroren” manufactured by Nippon Paper Industries Co., Ltd. In a case where the hydrogen sulfide adsorption layer 18 is formed by extrusion or the like, “Admer”, “Modic”, or the like is suitable as the acid-modified polyolefin resin. In a case where the hydrogen sulfide adsorption layer 18 is formed by coating with a coating liquid, “Hardlen” and “Auroren” are suitable as the acid-modified polyolefin resin. Since such acid-modified polyolefin resins have excellent reactivity with various metals and various polymers having various functional groups, heat seal properties can be imparted to the hydrogen sulfide adsorption layer 18 by taking advantage of the reactivity.

From the viewpoint of improving solubility and adhesiveness to metal or the like, the acid value of the acid-modified polyolefin resin may be 2 mgKOH/g or more, 6 mgKOH/g or more, 10 mgKOH/g or more, 12 mgKOH/g or more, 14 mgKOH/g or more, 15 mgKOH/g or more, 16 mgKOH/g or more, or 17 mgKOH/g or more. From the viewpoint of improving adhesiveness to a resin component, the acid value of the acid-modified polyolefin resin may be 30 mgKOH/g or less, 25 mgKOH/g or less, 20 mgKOH/g or less, 19 mgKOH/g or less, 18 mgKOH/g or less, or 17 mgKOH/g or less. The acid value of the acid-modified polyolefin resin may be 2 to 30 mgKOH/g, 10 to 20 mgKOH/g, or 15 to 20 mgKOH/g. The acid value of the acid-modified polyolefin resin is measured by a method according to JIS K 0070.

From the viewpoint of achieving sufficient heat resistance, the melting point of the acid-modified polyolefin resin may be 70° C. or higher, 80° C. or higher, 90° C. or higher, or 95° C. or higher. From the viewpoint of easily achieving excellent heat seal strength, the melting point of the acid-modified polyolefin resin may be 150° C. or lower, 140° C. or lower, 130° C. or lower, or 125° C. or lower. The melting point of the acid-modified polyolefin resin may be 70 to 150° C., 70 to 130° C., or 70 to 125° C.

From the viewpoint of easily achieving excellent heat seal strength, the content of the modified polyolefin resin, relative to the total amount of the hydrogen sulfide adsorption layer 18, may be 50 mass % or more, 60 mass % or more, 70 mass % or more, or 80 mass % or more. From the viewpoint of easily adsorbing hydrogen sulfide more efficiently, the content of the modified polyolefin resin, relative to the total amount of the hydrogen sulfide adsorption layer 18, may be 99 mass % or less, 97 mass % or less, 95 mass % or less, 93 mass % or less, or 90 mass % or less.

A hydrogen sulfide adsorbent means one capable of adsorbing and/or decomposing hydrogen sulfide. Examples of the hydrogen sulfide adsorbent include zinc oxide, amorphous metal silicate (mainly one including copper or zinc as metal), a hydrate of zirconium and lanthanoid elements, tetravalent metal phosphate (particularly one including copper as metal), a mixture of zeolite and zinc ions, a mixture of zeolite, zinc oxide, and copper oxide (II), potassium permanganate, sodium permanganate, silver sulfate, silver acetate, aluminum oxide, iron hydroxide, aluminum silicate, aluminum potassium sulfate, zeolite, hydrotalcite, complex oxide (mainly one including zinc as metal) activated carbon, an amine-based compound, and an ionomer. From the viewpoint of further easily detoxifying hydrogen sulfide as well as cost and handleability, the hydrogen sulfide adsorbent may contain zinc oxide (ZnO) and/or zinc ions. The hydrogen sulfide adsorbents may be used individually or in combination of two or more.

As the hydrogen sulfide adsorbent, a deodorant having the effect of deodorizing hydrogen sulfide may be used. Specific examples include “Daimushu PE-M3000-Z” manufactured by Dainichiseika Color & Chemicals Mfg. Co., Ltd., the “Kesumon” series manufactured by Toagosei Co., Ltd., “Shu-Cleanse” (a mixture of zeolite and zinc oxide) manufactured by Rasa Industries, Ltd., and “Dushlite ZU” (a mixture of zeolite and zinc) and “Dushlite CZU” (a mixture of zeolite, copper oxide, and zinc oxide) manufactured by Sinanen Zeomic Co., Ltd.

From the viewpoint of easily achieving excellent hydrogen sulfide absorbency, the mean particle diameter (D50) of the hydrogen sulfide adsorbent may be 0.01 μm or more, 0.05 μm or more, 0.1 μm or more, 0.3 μm or more, 0.5 μm or more, or 0.8 μm or more. From the viewpoint of improving dispersibility, the mean particle diameter (D50) of the hydrogen sulfide adsorbent may be 5 μm or less. From the viewpoint of increasing specific surface area and improving hydrogen sulfide adsorption performance, the mean particle diameter (D50) of the hydrogen sulfide adsorbent may be 10 μm or less, 8 μm or less, 7 μm or less, 6 μm or less, 5 μm or less, 4 μm or less, 3.5 μm or less, 3 μm or less, 2.5 μm or less, 2 μm or less, 1.8 μm or less, 1.6 μm or less, or 1.5 μm or less. From these viewpoints, the mean particle diameter (D50) of the hydrogen sulfide adsorbent may be 0.01 to 10 μm, 0.05 to 8 μm, 0.1 to 7 μm, 0.3 to 6 μm, 0.5 to 5 μm, or 0.8 to 4 μm. The mean particle diameter of the hydrogen sulfide adsorbent denotes a mean particle diameter measured by a dynamic light scattering method.

From the viewpoint of easily achieving excellent hydrogen sulfide absorbency, the content of the hydrogen sulfide adsorbent, relative to the total amount of the hydrogen sulfide adsorption layer 18, may be 0.1 mass % or more, 0.5 mass % or more, 1 mass % or more, 2 mass % or more, 3 mass % or more, or 5 mass % or more. From the viewpoint of easily achieving excellent heat seal strength, the content of the hydrogen sulfide adsorbent, relative to the total amount of the hydrogen sulfide adsorption layer 18, may be 50 mass % or less, 40 mass % or less, 30 mass % or less, 20 mass % or less, 15 mass % or less, or 10 mass % or less. The content of the hydrogen sulfide adsorbent, relative to the total amount of the hydrogen sulfide adsorption layer 18, may be 0.5 to 50 mass %, 1 to 50 mass %, or 1 to 30 mass %.

From the viewpoint of easily adsorbing hydrogen sulfide more efficiently, the mass ratio of the hydrogen sulfide adsorbent relative to the content of the modified polyolefin resin (content of hydrogen sulfide adsorbent/content of modified polyolefin resin) may be 0.005 or more, 0.01 or more, 0.02 or more, or 0.5 or more. From the viewpoint of easily achieving excellent heat seal strength, the mass ratio of the content of the hydrogen sulfide adsorbent relative to the content of the modified polyolefin resin may be 1 or less, 0.7 or less, 0.5 or less, or 0.3 or less.

The hydrogen sulfide adsorption layer 18 may contain, for example, a curing agent, a dispersant (for example, a surfactant such as metal soap), an antioxidant, a slip agent, a flame retardant, an antiblocking agent, a light stabilizer, a dehydrator, a tackifier, a crystal nucleating agent, and a plasticizer, in order to impart dispersibility, heat seal properties, heat resistance, and other functionalities.

Examples of the curing agent include an isocyanate compound, a carbodiimide compound, an oxazoline compound, and a glycidyl compound. From the viewpoint of heat resistance, the hydrogen sulfide adsorption layer 18 may further contain at least one selected from the group consisting of an isocyanate compound, a carbodiimide compound, and an oxazoline compound.

The isocyanate compound may be a polyfunctional isocyanate compound, and examples thereof include: diisocyanates such as tolylene diisocyanate, xylylene diisocyanate or a hydrogenated product thereof, hexamethylene diisocyanate, 4,4′-diphenylmethane diisocyanate or a hydrogenated product thereof, and isophorone diisocyanate; polyisiocyanates such as adducts obtained by reacting these isocyanates with a polyhydric alcohol such as trimethylolpropane, biurets obtained by allowing it to react with water, and isocyanurates as trimers; or blocked polyisocyanates obtained by blocking these polyisocyanates with alcohols, lactams, oximes, and the like.

Examples of the carbodiimide compound include N,N′-di-o-tolylcarbodiimide, N,N′-diphenylcarbodiimide, N,N′-di-2,6-dimethylphenylcarbodiimide, N,N′-bis(2,6-diisopropylphenyl) carbodiimide, N,N′-dioctyldecylcarbodiimide, N-tolyl-N′-cyclohexylcarbodiimide, N,N′-di-2,2-di-t-butylphenylcarbodiimide, N-triyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, and N,N′-di-p-tolylcarbodiimide.

Examples of the oxazoline compound include low molecular weight compounds having two or more oxazoline units. An alternative example, when a polymerizable monomer such as isopropenyloxazoline is used, is compounds obtained by copolymerizing acrylic monomers such as (meth)acrylic acid, (meth)acrylic acid alkyl ester, and hydroxyalkyl (meth)acrylate.

From the viewpoint of excellence in heat resistance and film cohesive forces, the content of the curing agent, relative to the functional group of the modified polyolefin resin, may be 0.05 equivalent or more, 0.1 equivalent or more, or 0.2 equivalent or more. From the viewpoint of preventing the hydrogen sulfide adsorption layer 18 from becoming brittle, the content of the curing agent, relative to the functional group of the modified polyolefin resin, may be 2 equivalents or less, 1 equivalent or less, or 0.7 equivalent or less. From these viewpoints, the content of the curing agent, relative to the functional group of the modified polyolefin resin, may be 0.05 to 2 equivalents, 0.1 to 1 equivalent, or 0.1 to 0.7 equivalent.

From the viewpoint of striking a balance between excellent heat seal strength and excellent hydrogen sulfide absorbency, the thickness of the hydrogen sulfide adsorption layer 18 is equal to or more than 0.5 μm and less than 10 μm. From the viewpoint of easily achieving excellent hydrogen sulfide adsorption performance, the thickness of the hydrogen sulfide adsorption layer 18 may be 1 μm or more, 1.5 μm or more, 2 μm or more, or 3 μm or more. From the viewpoint of easily achieving excellent heat seal strength, the thickness of the hydrogen sulfide adsorption layer 18 may be 9 μm or less, 8 μm or less, 7 μm or less, 6 μm or less, 5 μm or less, less than 5 μm, 4 μm or less, or 3 μm or less. The thickness of the hydrogen sulfide adsorption layer 18 may be 1 to 9 μm, equal to or more than 1 μm and less than 5 μm, or 1 to 4 μm. When the hydrogen sulfide adsorption layers 18 is a plurality of layers, the total thickness of the plurality of the hydrogen sulfide adsorption layers 18 may be in the above-described range, or the thickness of each of the plurality of the hydrogen sulfide adsorption layers 18 may be in the above-described range.

The ratio of the thickness of the hydrogen sulfide adsorption layer 18 relative to the thickness of the sealant layer 16 (thickness of hydrogen sulfide adsorption layer 18/thickness of sealant layer 16) may be 0.01 or more, 0.03 or more, or 0.05 or more from the viewpoint of easily achieving excellent hydrogen sulfide adsorption performance and may be 0.5 or less, 0.3 or less, or 0.2 or less from the viewpoint of easily achieving excellent heat seal strength. From these viewpoints, the ratio of the thickness of the hydrogen sulfide adsorption layer 18 to the thickness of the sealant layer 16 may be 0.01 to 0.5, 0.03 to 0.3, or 0.05 to 0.2. When the sealant layer 16 and/or the hydrogen sulfide adsorption layer are a plurality of layers, the ratio of the thickness of the hydrogen sulfide adsorption layer 18 to the thickness of the sealant layer 16 is calculated based on the total thickness of the plurality of layers.

The hydrogen sulfide adsorption layer 18 may be formed by coating with a coating liquid that contains at least a modified polyolefin resin and a hydrogen sulfide adsorbent. When the hydrogen sulfide adsorption layer 18 having a thickness of less than 10 μm is difficult to obtain by an extrusion method, the hydrogen sulfide adsorption layer 18 having a thickness of less than 10 μm is easily obtained by forming the hydrogen sulfide adsorption layer 18 by coating with the coating liquid. The hydrogen sulfide adsorption layer can be formed by a common coating method such as a direct gravure method, a reverse gravure method, a wire-bar coating method, or a micro-gravure method.

When the coating liquid contains a curing agent, the functional group of the modified polyolefin resin and the curing agent can react with each other to form the hydrogen sulfide adsorption layer 18 having excellent heat seal strength and cohesive forces. Further, when the coating liquid contains a curing agent, aging is preferably performed from the viewpoint of sufficiently completing the curing reaction. The aging temperature may be room temperature (25° C.) to 100° C. When the aging temperature is room temperature or higher, the curing reaction easily proceeds. When the aging temperature is 100° C. or lower, crystallization of the sealant layer 16 is easily suppressed. The aging time is preferably a time which allows the reaction rate of the curing agent to reach 80% or more. When the reaction rate of the curing agent is 80% or more, the crosslinking effect by the curing agent is sufficiently expressed.

Further, since the hydrogen sulfide adsorption layer 18 is the outermost layer of the packaging material 10 as in the packaging material 10 shown in FIG. 1, batch production by a production method similar to a known method is possible before the step of forming the hydrogen sulfide adsorption layer 18, and only the necessary quantities of the packaging materials 10 having hydrogen sulfide adsorption performance can be produced, which is also advantageous in terms of production cost.

Preferred embodiments of the packaging material for all-solid-state batteries of the present embodiment have been described in detail. However, the present disclosure is not limited to such specific embodiments, which can be variously modified or changed within the spirit of the present disclosure recited in the claims.

For example, although the anti-corrosion treatment layers 14a and 14b are disposed on both surfaces of the gas barrier layer 13 in FIG. 1, only one of the anti-corrosion treatment layers 14a and 14b may be disposed, or no anti-corrosive treatment layer may be disposed.

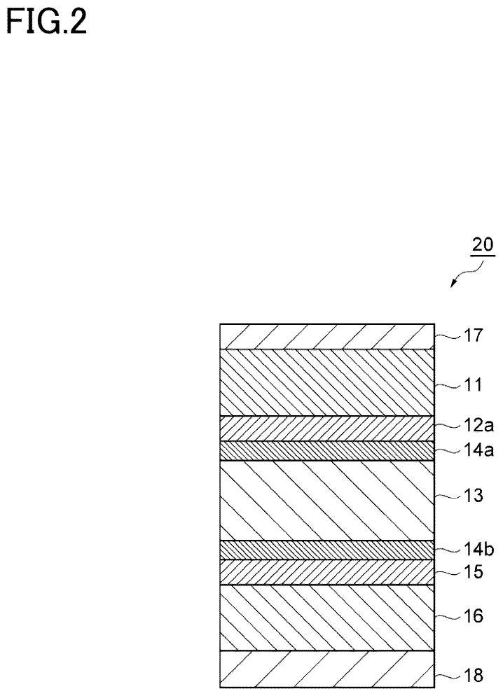

Although the second adhesive layer 12b is used to laminate the gas barrier layer 13 and the sealant layer 16 in FIG. 1, an adhesive resin layer 15 may be used to laminate the gas barrier layer 13 and the sealant layer 16 as in a packaging material (packaging material for all-solid-state batteries) 20 shown in FIG. 2. Further, in the packaging material 20 shown in FIG. 2, the second adhesive layer 12b may be disposed between the gas barrier layer 13 and the adhesive resin layer 15.

### <Adhesive Resin Layer 15>

The adhesive resin layer 15 is configured to contain an adhesive resin composition as the main component and, as necessary, additive component(s). The adhesive resin composition is not particularly limited, but preferably contains a modified polyolefin resin.

The modified polyolefin resin is preferably a polyolefin resin graft-modified with an unsaturated carboxylic acid derivative derived from any one of an unsaturated carboxylic acid as well as an acid anhydride and an ester thereof.

Examples of the polyolefin resin include low-density polyethylene, medium-density polyethylene, high-density polyethylene, an ethylene-α-olefin copolymer, homopolypropylene, block polypropylene, random polypropylene, and a propylene-α-olefin copolymer.

The modified polyolefin resin is preferably a polyolefin resin modified with maleic anhydride. Examples of a suitable modified polyolefin resin include “Admer” manufactured by Mitsubishi Chemical Corporation, “Modic” manufactured by Mitsubishi Chemical Corp., “Hardlen” manufactured by Toyobo Co., Ltd., and “Auroren” manufactured by Nippon Paper Industries Co., Ltd. Since such modified polyolefin resins have excellent reactivity with various metals and various polymers having various functional groups, adhesiveness can be imparted to the adhesive resin layer 15 by taking advantage of the reactivity. Further, the adhesive resin layer 15 may contain, as necessary, various additives such as various compatible or incompatible elastomers, a flame retardant, a slip agent, an anti-blocking agent, an antioxidant, a light stabilizer, and a tackifier.

The thickness of the adhesive resin layer 15 is not particularly limited, but is preferably the same as or less than that of the sealant layer 16, from the viewpoint of stress relaxation and moisture permeability.

In the packaging material 20, the total thickness of the adhesive resin layer 15 and the sealant layer 16 is preferably in the range of 5 to 100 μm and more preferably in the range of 20 to 80 μm, from the viewpoint of striking a balance between the thinning of a film and the improvement of heat seal strength under a high temperature environment.

Like the packaging material 20 shown in FIG. 2, the packaging material of the present disclosure may further include a protective layer 17 disposed on a surface of the substrate layer 11 opposite to that facing toward to gas barrier layer 13.

### <Protective Layer 17>

The protective layer 17 is a layer that protects the substrate layer 11. As a material for constituting the protective layer 17, a material similar to that of the first adhesive layer 12a can be used. The protective layer 17 can be formed on the substrate layer 11 by coating or the like. The protective layer 17 may contain a hydrogen sulfide adsorbent and/or a color developer. When a color developer is contained in the protective layer 17, which is the outermost layer in the packaging material 20, an abnormality occurring in any one of the all-solid-state batteries within a module resulting in leakage of hydrogen sulfide can be easily found, and the all-solid-state battery having the abnormality can be easily identified.

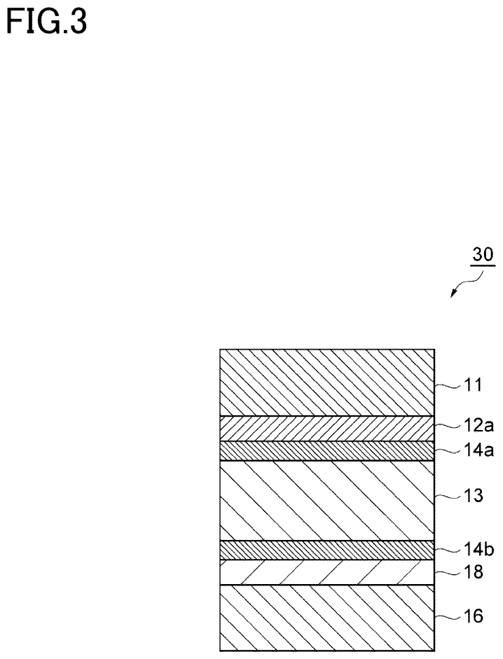

In the packaging material of the present disclosure, as in a packaging material (packaging material for all-solid-state batteries) 30 shown in FIG. 3, the hydrogen sulfide adsorption layer 18 may be disposed on a surface of the sealant layer 16 facing toward the gas barrier layer 13. When the hydrogen sulfide adsorption layer 18 is disposed on a surface of the sealant layer 16 facing the gas barrier layer 13, the hydrogen sulfide adsorption layer 18 serves as a layer for bonding the gas barrier layer 13 and the sealant layer 16. Therefore, as shown in FIG. 3, the second adhesive layer 12b and the adhesive resin layer 15 may be omitted.

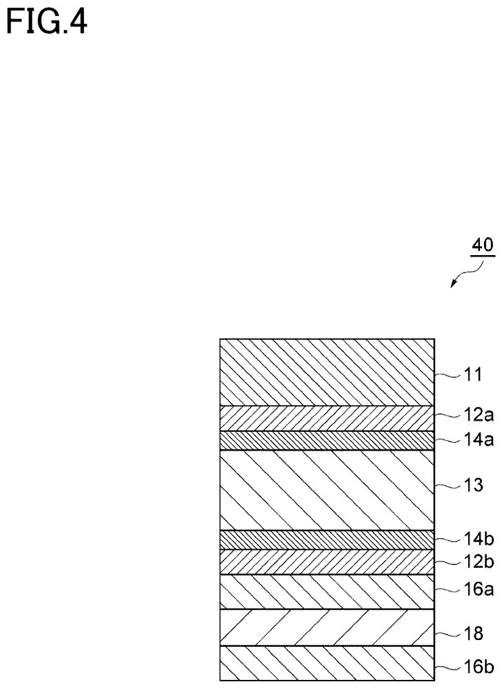

The packaging material of the present disclosure, like a packaging material (packaging material for all-solid-state batteries) 40 shown in FIG. 4, may have a first sealant layer 16a and a second sealant layer 16b. The first sealant layer 16a and the second sealant layer 16b may be each formed of the above-described material for constituting the sealant layer 16. The first sealant layer 16a may have a thickness of 5 to 100 μm or 20 to 80 μm. The second sealant layer 16b may have a thickness of 5 to 100 μm or 20 to 80 μm.

### [Method of Producing Packaging Material]

Next, an example of a method of producing the packaging material 10 shown in FIG. 1 will be described. Note that the method of producing the packaging material 10 is not limited to the following production method.

The method of producing the packaging material 10 of the present embodiment includes: a step of providing anti-corrosion treatment layers 14a and 14b on a gas barrier layer 13, a step of bonding a substrate layer 11 and the gas barrier layer 13 using a first adhesive layer 12a, a step of laminating a sealant layer 16 via a second adhesive layer 12b, and a step of laminating a hydrogen sulfide adsorption layer on the sealant layer 16 to prepare a laminate. The method of producing the packaging material 10 may include, as necessary, a step of aging the obtained laminate.

### (Step of Laminating Anti-Corrosion Treatment Layers 14a and 14b to Gas Barrier Layer 13)

The present step is a step of forming anti-corrosion treatment layers 14a and 14b on a gas barrier layer 13. Examples of a method therefor include, as described above, performing, on the gas barrier layer 13, a degreasing treatment, a hydrothermal modification treatment, an anodic oxidation treatment, or a chemical conversion treatment, and coating with a coating agent having anti-corrosion performance.

When the anti-corrosion treatment layers 14a and 14b are multi-layers, for example, a coating liquid (coating agent) for constituting an anti-corrosion treatment layer on the lower side (on the gas barrier 13 side) may be applied on the gas barrier layer 13 and baked to form a first layer, and thereafter a coating liquid (coating agent) for constituting an anti-corrosion treatment layer on the upper layer side may be applied on the first layer and baked to form a second layer.

The degreasing treatment may be performed by a spraying method or an immersion method. The hydrothermal modification treatment and the anodic oxidation treatment may be performed by an immersion method. The chemical conversion treatment may be performed by appropriately selecting an immersion method, a spraying method, a coating method, or the like depending on the type of the chemical conversion treatment.

The usable coating method of the coating agent having anti-corrosion performance can be various methods such as gravure coating, reverse coating, roll coating, and bar coating.

As described above, various treatments are performed on either both surfaces or one surface of a metal foil. When various treatments are single-surface treatments, the treatment surface is preferably on a side on which the sealant layer 16 is laminated. Note that the surface of the substrate layer 11 may also be subjected to the aforementioned treatments as required.

The coating weights of the coating agents for forming the first layer and the second layer are each preferably 0.005 to 0.200 g/m² and more preferably 0.010 to 0.100 g/m².

Further, in a case where dry curing is necessary, the curing can be performed in the range of 60 to 300° C. as the base material temperature depending on the drying conditions of the anti-corrosion treatment layers 14a and 14b used.

### (Step of Bonding Substrate Layer 11 and Gas Barrier Layer 13)

The present step is a step of bonding the gas barrier layer 13 provided with the anti-corrosion treatment layers 14a and 14b with a substrate layer 11 via a first adhesive layer 12a. The bonding method is bonding them using the above-described material constituting the first adhesive layer 12a, by a technique such as dry lamination, non-solvent lamination, or wet lamination. The dry coating weight of the first adhesive layer 12a may be 1 to 10 g/m² and more preferably 2 to 7 g/m².

### (Step of Laminating Second Adhesive Layer 12b and Sealant Layer 16)

The present step is a step of bonding a sealant layer 16 to the second anti-corrosion treatment layer 14b side of the gas barrier layer 13 via a second adhesive layer 12b. Examples of the bonding method include wet processing and dry lamination.

For wet processing, a solution or a dispersion of an adhesive constituting the second adhesive layer 12b is applied onto the second anti-corrosion treatment layer 14b, and the solvent is evaporated at a predetermined temperature for dry film formation, or baking is performed as necessary after dry film formation. Then, the sealant layer 16 is laminated to produce a packaging material 10. Examples of the coating method include the coating methods described above as examples. The preferable dry coating weight of the second adhesive layer 12b is the same as that of the first adhesive layer 12a.

In this case, the sealant layer 16 can be produced by, for example, a melt extrusion molding machine, with a sealant layer-forming resin composition which contains the above-described constituent components of the sealant layer 16. In the melt extrusion molding machine, the processing speed can be set to 80 m/min or more, from the viewpoint of productivity.

### (Step of Laminating Hydrogen Sulfide Adsorption Layer 18)

The present step is a step of laminating a hydrogen sulfide adsorption layer 18 to a side of the sealant layer 16 opposite to that facing the second adhesive layer 12b, to obtain a laminate. The hydrogen sulfide adsorption layer 18 can be formed by, for example, forming a coating film with a resin composition for forming the hydrogen sulfide adsorption layer 18 which contains the above-described constituent components of the hydrogen sulfide adsorption layer 18 by a common coating method such as a direct gravure method, a reverse gravure method, a wire-bar coating method, or a micro-gravure method, and drying the formed coating film at 40 to 150° C. for 10 to 180 seconds. The drying condition of the coating film can be adjusted depending on the type of the solvent used for the resin composition for forming the hydrogen sulfide adsorption layer 18, the film thickness of the hydrogen sulfide adsorption layer, and the like. The hydrogen sulfide adsorption layer 18 may be formed by an extrusion method using an extrusion laminator or the like.

### (Aging Step)

The present step is a step of aging (curing) the laminate. Aging the laminate can promote adhesion among the gas barrier layer 13/the second anti-corrosion treatment layer 14b/the second adhesive layer 12b/the sealant layer 16/the hydrogen sulfide adsorption layer 18. Aging may be performed in the range from room temperature to 100° C. The aging time may be, for example, 1 to 10 days.

In this manner, the packaging material 10 of the present embodiment, as shown in FIG. 1, can be produced. When the packaging material includes the adhesive resin layer 15 in place of the second adhesive layer 12b as in the packaging material 20 shown in FIG. 2, the following step may be included in place of the step of laminating the second adhesive layer 12b and the sealant layer 16.

### (Step of Laminating Adhesive Resin Layer 15 and Sealant Layer 16)

The present step is a step of forming the adhesive resin layer 15 and the sealant layer 16 on the second anti-corrosion treatment layer 14b formed in the previous step. An example of a method therefor is a method of using an extrusion laminator to sandwich-laminate the adhesive resin layer 15 together with the sealant layer 16. The adhesive resin layer 15 and the sealant layer 16 may also be laminated on the anti-corrosion treatment layer 14b by a tandem lamination method or a co-extrusion method of extruding the adhesive resin layer 15 and the sealant layer 16. In forming the adhesive resin layer 15 and the sealant layer 16, for example, components are formulated to satisfy the above-described configurations of the adhesive resin layer 15 and the sealant layer 16. The sealant layer 16 is formed using the above-described resin composition for forming a sealant layer.

Note that the adhesive resin layer 15 may be laminated by directly extruding, using an extrusion laminator, a material which has been dry-blended to have the above-described material formulation composition. The adhesive resin layer 15 may also be laminated by extruding, using an extrusion laminator, a granulated substance which has been granulated after previously being melt-blended using a melt blender such as a single-screw extruder, a twin-screw extruder, or a Brabender mixer.

The sealant layer 16 may also be laminated by directly extruding, using an extrusion laminator, a material which has been dry-blended to have the above-described material formulation composition as constituent components of the resin composition for forming a sealant layer. Alternatively, the adhesive resin layer 15 and the sealant layer 16 may be laminated by a tandem lamination method or a co-extrusion method of extruding the adhesive resin layer 15 and the sealant layer 16 using an extrusion laminator, with a granulated substance after having been previously melt-blended using a melt blender such as a single-screw extruder, a twin-screw extruder, or a Brabender mixer. Further, lamination may be performed by a method of previously forming a sealant single film as a cast film with the resin composition for forming a sealant layer and sandwich-laminating this film together with an adhesive resin. From the viewpoint of productivity, the formation speed (processing speed) of the adhesive resin layer 15 and the sealant layer 16 can be, for example, 80 m/min or more.

Next, an example of the method of producing a packaging material 30 shown in FIG. 3 will be described. Note that the method of producing the packaging material 30 is not limited to the following method.

The method of producing the packaging material 30 of the present embodiment includes a step of disposing anti-corrosion treatment layers 14a and 14b on a gas barrier layer 13, a step of bonding a substrate layer 11 and the gas barrier layer 13 with a first adhesive layer 12a, and a step of further laminating a hydrogen sulfide adsorption layer 18 and a sealant layer 16 to prepare a laminate, and contains, as necessary, a step of heating the resultant laminate. Steps to the step of bonding a substrate layer 11 and the gas barrier layer 13 can be performed in the same manner as the above-described method of producing the packaging material 10.

### (Step of Laminating Hydrogen Sulfide Adsorption Layer 18 and Sealant Layer 16)

The present step is a step of forming a hydrogen sulfide adsorption layer 18 and a sealant layer 16 on the second anti-corrosion treatment layer 14b formed in the previous step. The hydrogen sulfide adsorption layer 18 and the sealant layer 16 can be laminated on the second anti-corrosion treatment layer 14b by a tandem lamination method or a co-extrusion method of extruding the hydrogen sulfide adsorption layer 18 and the sealant layer 16 by an extrusion laminator, with a granulated substance (kneaded product of a resin composition for forming each layer) after having been previously melt-blended using a melt blender such as a single-screw extruder, a twin-screw extruder, or a Brabender mixer. In forming the hydrogen sulfide adsorption layer 18 and the sealant layer 16, for example, components are formulated to satisfy the above-described configurations of the hydrogen sulfide adsorption layer 18 and the sealant layer 16. The above-described resin composition for forming a sealant layer is used for forming the sealant layer 16, and the above-described resin composition for forming the hydrogen sulfide adsorption layer 18 is used for forming the hydrogen sulfide adsorption layer 18.

Through the present step, there is obtained a laminate, as shown in FIG. 3, in which layers are laminated in the order of the substrate layer 11/the first adhesive layer 12a/the first anti-corrosion treatment layer 14a/the gas barrier layer 13/the second anti-corrosion treatment layer 14b/the hydrogen sulfide adsorption layer 18/the sealant layer 16.

### (Heating Step)

The present step is a step of heating the laminate. Heating the laminate can improve adhesion among the gas barrier layer 13/the second anti-corrosion treatment layer 14b/the hydrogen sulfide adsorption layer 18/the sealant layer 16. The heating method is preferably treating at least at a temperature higher than the melting point of the hydrogen sulfide adsorption layer 18.

In this manner, the packaging material 30 of the present embodiment as shown in FIG. 3 can be produced.

Next, an example of the method of producing a packaging material 40 shown in FIG. 4 will be described. Note that the method of producing the packaging material 40 is not limited to the following method.

The method of producing the packaging material 40 of the present embodiment includes a step of providing anti-corrosion treatment layers 14a and 14b on a gas barrier layer 13, a step of bonding a substrate layer 11 and the gas barrier layer 13 using a first adhesive layer 12a, a step of laminating a second adhesive layer 12b and a first sealant layer 16a, and a step of further laminating a hydrogen sulfide adsorption layer 18 and a second sealant layer 16b to prepare a laminate, and contains, as necessary, a step of heating the resultant laminate. Steps to the step of bonding a substrate layer 11 and the gas barrier layer 13 can be performed in the same manner as the above-described method of producing the packaging material 10.

### (Step of Laminating Second Adhesive Layer 12b and Sealant Layer 16a)

The present step is a step of bonding a first sealant layer 16a to the second anti-corrosion treatment layer 14b side of the gas barrier layer 13 via a second adhesive layer 12b. The present step can be performed in the same manner as the above-described step of laminating the second adhesive layer 12b and the sealant layer 16.

### (Step of Laminating Hydrogen Sulfide Adsorption Layer 18 and Second Sealant Layer 16b)

The present step is a step of forming a hydrogen sulfide adsorption layer 18 and a second sealant layer 16b on the first sealant layer 16a formed in the previous step. The hydrogen sulfide adsorption layer 18 and the second sealant layer 16b can be laminated on the first sealant layer 16a by a tandem lamination method or a co-extrusion method of extruding the hydrogen sulfide adsorption layer 18 and the second sealant layer 16b by an extrusion laminator, with a granulated substance (kneaded product of a resin composition for forming each layer) after having been previously melt-blended using a melt blender such as a single-screw extruder, a twin-screw extruder, or a Brabender mixer. In forming the hydrogen sulfide adsorption layer 18 and the second sealant layer 16b, for example, components are formulated to satisfy the above-described configurations of the hydrogen sulfide adsorption layer 18 and the sealant layer 16. The above-described resin composition for forming a sealant layer is used for forming the second sealant layer 16b, and the above-described resin composition for forming the hydrogen sulfide adsorption layer 18 is used for forming the hydrogen sulfide adsorption layer 18.

Through the present step, there is obtained a laminate as shown in FIG. 4 in which layers are laminated in the order of the substrate layer 11/the first adhesive layer 12a/the first anti-corrosion treatment layer 14a/the gas barrier layer 13/the second anti-corrosion treatment layer 14b/the second adhesive layer 12b/the first sealant layer 16a/the hydrogen sulfide adsorption layer 18/the second sealant layer 16b.

### (Heating Step)

The present step is a step of heating the laminate. Heating the laminate can improve adhesion among the gas barrier layer 13/the second anti-corrosion treatment layer 14b/the second adhesive layer 12b/the first sealant layer 16a/the hydrogen sulfide adsorption layer 18/the second sealant layer 16b. The heating method is preferably treating at least at a temperature higher than the melting point of the hydrogen sulfide adsorption layer 18.

In this manner, the packaging material 40 of the present embodiment as shown in FIG. 4 can be produced.

Preferred embodiments of the packaging material for all-solid-state batteries of the present disclosure have been described in detail. However, the present disclosure is not limited to such specific embodiments, which can be variously modified or changed within the spirit of the present disclosure recited in the claims.

### [All-Solid-State Battery]

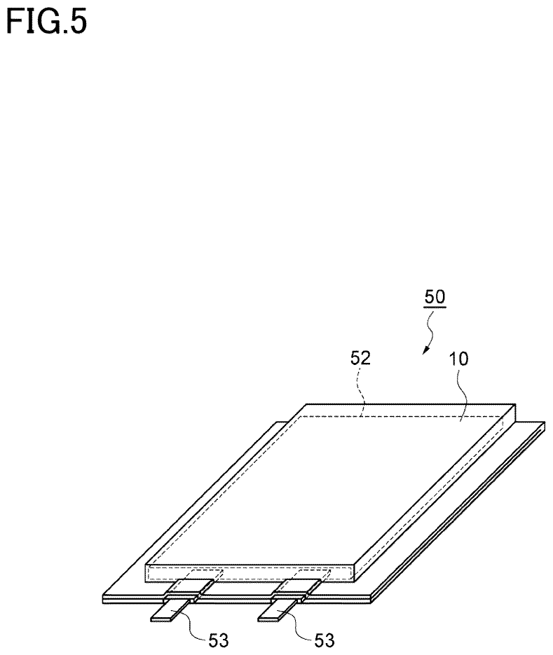

FIG. 5 is a perspective view showing an embodiment of an all-solid-state battery prepared with the above-described packaging material. As shown in FIG. 5, an all-solid-state battery 50 includes a battery element 52, two metal terminals (current-extraction terminals) 53 extending from the battery element 52 for externally extracting current, and the packaging material 10 which hermetically encloses the battery element 52. The packaging material 10 is the packaging material 10 according to the above-described present embodiment and is used as a container that houses the battery element 52. In the packaging material 10, the substrate layer 11 is the outermost layer, and the hydrogen sulfide adsorption layer 18 is the innermost layer. That is, the packaging material 10 is configured to enclose the battery element 52 therein, by folding one laminate film into two such that the substrate layer 11 is on the outer side of the all-solid-state battery 50, and the hydrogen sulfide adsorption layer 18 is on the inner side of the all-solid-state battery 50, and thermally fusing the edges, or by stacking two laminate films on each other and thermally fusing the edges. Note that the all-solid-state battery 50 may include the packaging material 20, the packaging material 30, or the packaging material 40, in place of the packaging material 10.

The battery element 52 includes positive and negative electrodes and a sulfide-based solid electrolyte disposed therebetween. The metal terminals 53 are each obtained by exposing a part of a current collector outside the packaging material 10, and are formed of a metal foil such as a copper foil or an aluminum foil. The metal terminals 53 are sandwiched and hermetically sealed by the packaging material 10 which forms a container with the hydrogen sulfide adsorption layer 18 being on the inner side. The metal terminals 53 may be sandwiched by the packaging material 10 via a tab sealant.

### EXAMPLES

Hereinafter, the present disclosure will be more specifically described based on examples. However, the present disclosure is not limited to the following examples.

### [Materials Used]

Materials used in Examples and Comparative Examples will be illustrated below.

<Substrate Layer (Thickness: 15 μm)>

A nylon (Ny) film (manufactured by Toyobo Co., Ltd.) was used.

### <First Adhesive Layer (Thickness: 5 μm, Substrate Layer Side)>

A polyurethane-based adhesive (manufactured by Toyo Ink Co., Ltd.), obtained by formulating a tolylene diisocyanate adduct-based curing agent to a polyester polyol-based base resin, was used.

### <First Anti-Corrosion Treatment Layer (Substrate Layer Side) and Second Anti-Corrosion Treatment Layer (Sealant Layer Side)>

(CL-1): A “sodium polyphosphate stabilized cerium oxide sol”, whose solid content concentration was adjusted to 10 mass % with distilled water as a solvent, was used. Note that the sodium polyphosphate stabilized cerium oxide sol was obtained by formulating 10 parts by mass of Na salt of phosphoric acid per 100 parts by mass of cerium oxide.

(CL-2): A composition including 90 mass % of a “polyallylamine (manufactured by Nitto Boseki Co., Ltd)” and 10 mass % of a “polyglycerol polyglycidyl ether (manufactured by Nagase Chemtex Corp.)”, whose solid concentration was adjusted to 5 mass % with distilled water as a solvent, was used.

<Gas Barrier Layer (Thickness: 40 μm)>

An annealed and degreased soft aluminum foil (“8079” manufactured by Toyo Aluminum K.K.) was used.

<Adhesive Resin Layer (Thickness: 20 μm)>

As an adhesive resin, a random polypropylene (PP)-based acid-modified polypropylene resin composition (manufactured by Mitsui Chemicals Inc.) was used.

<Sealant Layer (Thickness: 60 μm)>

A polypropylene-polyethylene random copolymer (manufactured by Prime Polymer Co., Ltd., trade name: F744NP) was used as a resin composition for forming a sealant layer.

### <Hydrogen Sulfide Adsorption Layer>

The polyolefin solution, the hydrogen sulfide adsorbent, and the curing agent described below were used in the combination illustrated in Table 1 to obtain a resin composition for forming a hydrogen sulfide adsorption layer.

### (Polyolefin Solution)

Liquid A: manufactured by Toyobo Co., Ltd., trade name PMA-T, solvent-based, acid value 17 mgKOH/g, melting point 95° C., maleic acid-modified polypropylene
Liquid B: manufactured by Toyobo Co., Ltd., trade name NZ-1029, water dispersion-based, acid value 12 mgKOH/g, melting point 95° C., maleic acid-modified polypropylene
Liquid C: manufactured by Toyobo Co., Ltd., trade name PMA-KH, solvent-based, acid value 12 mgKOH/g, melting point 80° C., maleic acid-modified polypropylene
Liquid D: manufactured by Toyobo Co., Ltd., trade name PMA-L, solvent-based, acid value 17 mgKOH/g, melting point 70° C., maleic acid-modified polypropylene
Liquid E: manufactured by Toyobo Co., Ltd., trade name NZ-1022, water dispersion-based, acid value 17 mgKOH/g, melting point 125° C., maleic acid-modified polypropylene
Liquid F: manufactured by Toyobo Co., Ltd., trade name Vylon 20SS, solvent-based, acid value 6 mgKOH/g, melting point 170° C., polyester polyol

### (Hydrogen Sulfide Adsorbent)

Agent A: manufactured by Sinanen Zeomic Co., Ltd., trade name Dushlite ZH, mean particle diameter (D50) 1.5 μm
Agent B: manufactured by Sinanen Zeomic Co., Ltd., trade name Dushlite CZU, mean particle diameter (D50) 4 μm
Agent C: manufactured by Rasa Industries, Ltd., trade name Shu-Cleanse KD-211 grade GU, mean particle diameter (D50) 0.8 μm

### (Curing Agent)

Isocyanate: manufactured by Tosoh Corporation, trade name Coronate 2031, 1 equivalent relative to an acid group in maleic acid-modified polypropylene or a hydroxyl group in polyester polyol
Carbodilite: manufactured by Nisshinbo Holdings Inc., trade name V-02-L2, 0.5 equivalents relative to acid groups in maleic acid-modified polypropylene
Oxazoline: manufactured by Nippon Shokubai Co., Ltd., trade name WS-300, 0.5 equivalents relative to acid groups in maleic acid-modified polypropylene

### [Preparation of Packaging Material]

### Examples 1 and 4 to 17, Comparative Examples 1 and 2

Firstly, first and second anti-corrosion treatment layers were disposed on a gas barrier layer in the following procedure. That is, (CL-1) was applied onto both surfaces of a gas barrier layer by micro gravure coating at a dry coating weight of 70 mg/m², and baked at 200° C. in a drying unit. Next, (CL-2) was applied onto the obtained layer by micro gravure coating at a dry coating weight of 20 mg/m², so that composite layers including (CL-1) and (CL-2) were formed as first and second anti-corrosion treatment layers. The composite layer was obtained by compounding two materials (CL-1) and (CL-2) to develop corrosion prevention performance.

Next, the first anti-corrosion treatment layer side of the gas barrier layer provided with the first and second anti-corrosion treatment layers was dry-laminated to a substrate layer with a polyurethane-based adhesive (first adhesive layer). Lamination of the gas barrier layer and the substrate layer was performed by applying a polyurethane-based adhesive on a surface at the first anti-corrosion treatment layer side of the gas barrier layer such that a thickness after curing was 5 μm, drying the coat at 80° C. for 1 minute, laminating the dried coat to a substrate layer, and aging the laminate at 60° C. for 72 hours.

Next, the laminate of the barrier layer and the substrate layer was set in an unwinding unit of an extrusion laminator, and co-extrusion was performed on the second anti-corrosion treatment layer under the processing conditions of 270° C. and 100 m/min to laminate an adhesive resin layer (thickness: 20 μm) and a sealant layer (thickness: 60 μm) in this order. Note that for the adhesive resin layer and the sealant layer, a compound of various materials was previously prepared using a twin-screw extruder, subjected to water cooling and pelletization processes, and used for the above-described extrusion lamination.

Next, a resin composition for forming a hydrogen sulfide adsorption layer was applied on a surface of the sealant layer by a gravure coating method such that a film thickness after drying was 5 μm, dried at 100° C. for 1 minute, and thereafter aged at 60° C. for 72 hours to form a hydrogen sulfide adsorption layer.

The thus-obtained laminate was heated such that the maximum attainable temperature of the laminate was 190° C. to prepare a packaging material (a laminate of the substrate layer/the first adhesive layer/the first anti-corrosion treatment layer/the gas barrier layer/the second anti-corrosion treatment layer/the adhesive resin layer/the sealant layer/the hydrogen sulfide adsorption layer).

### Example 2

In the same manner as in Example 1, a laminate of a barrier layer and a substrate layer was prepared. Next, the laminate of the barrier layer and the substrate layer was set in an unwinding unit of an extrusion laminator, and co-extrusion was performed on the second anti-corrosion treatment layer under the processing conditions of 270° C. and 100 m/min to laminate a hydrogen sulfide adsorption layer (thickness: 20 μm) and a sealant layer (thickness: 60 μm) in this order. Note that for the hydrogen sulfide adsorption layer and the sealant layer, a compound of materials for forming each layer was previously prepared using a twin-screw extruder, subjected to water cooling and pelletization processes, and used for the above-described extrusion lamination.

The thus-obtained laminate was heated such that the maximum attainable temperature of the laminate was 190° C. to prepare a packaging material (a laminate of the substrate layer/the first adhesive layer/the first anti-corrosion treatment layer/the gas barrier layer/the second anti-corrosion treatment layer/the hydrogen sulfide adsorption layer/the sealant layer).

### Example 3

In the same manner as in Example 1, a laminate of a barrier layer and a substrate layer was prepared. Next, in the same manner as in Example 1, the laminate of the barrier layer and the substrate layer was set in an unwinding unit of an extrusion laminator, and co-extrusion was performed on the second anti-corrosion treatment layer under the processing conditions of 270° C. and 100 m/min to obtain a laminate in which the adhesive resin layer (thickness: 20 μm), the first sealant layer (thickness: 20 μm), the hydrogen sulfide adsorption layer (thickness: 5 μm), and the second sealant layer (thickness: 35 μm) were laminated in this order.

### [Measurement of Heat Seal Strength]

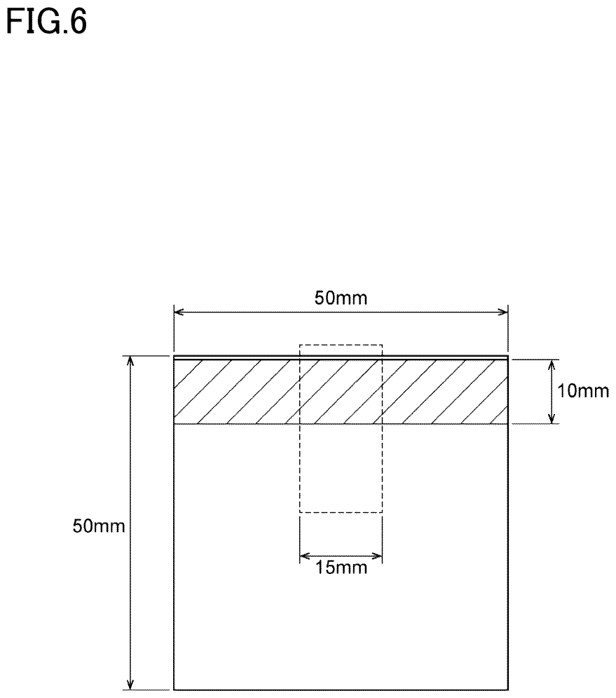

A sample obtained by cutting the prepared packaging material into a size of 50 mm (TD)×100 mm (MD) was folded in two so as to sandwich a chemical conversion-treated aluminum foil cut to a size of 50 mm×50 mm, and edge portions opposite the folded portion were heat sealed with a width of 10 mm at 180° C./0.6 MPa/10 seconds. Thereafter, the central portion in the lengthwise direction of the heat sealed portion was cut out to a width of 15 mm (see FIG. 6) to prepare a sample for measuring heat seal strength. This sample for measuring heat seal strength was subjected to a T-peel test under the conditions of a tensile speed of 50 mm/min in a room temperature (25° C.) environment and in an 80° C. environment, using a tensile tester (manufactured by Shimadzu Corporation). From the obtained result, the heat seal strength (burst strength) was evaluated according to the following evaluation criteria.
A: Heat seal strength is 20 N/15 mm or more.
B: Heat seal strength is equal to or more than 15 N/15 mm and less than 20 N/15 mm.
C: Heat seal strength is less than 15 N/15 mm.

### [Evaluation of Hydrogen Sulfide (H₂S) Absorbency]

The packaging material was cut to a size of 50 mm×50 mm to obtain a sample for evaluating hydrogen sulfide absorbability. This sample was placed in a 2 L Tedlar bag, and the Tedler bag was sealed. Into this Tedler bag, 2 L of hydrogen sulfide gas having a concentration of 20 ppm by mass was introduced, and left to stand at room temperature (25° C.) for 144 hours. The hydrogen sulfide concentration in the Tedler bag after being left to stand for 144 hours was measured. Table 1 shows the measurement results.

TABLE 1

| | | | | | | Evaluation | | |
|---|---|---|---|---|---|---|---|---|
| | | | | | | Seal strength | | |
| | | Hydrogen sulfide | | | Film | (N/15 mm) | | H₂S |
| | Polyolefin | adsorbent | | Curing | thickness | Room | | absorbency |
| | solution | Component | Content | agent | (μm) | temperature | 80° C. | (ppm) |
| Example 1 | Liquid A | Agent A | 5 wt % | — | 3 | A | A | 3 |
| Example 2 | Liquid A | Agent A | 5 wt % | — | 3 | A | A | 5 |
| Example 3 | Liquid A | Agent A | 5 wt % | — | 3 | A | A | 5 |
| Example 4 | Liquid C | Agent A | 5 wt % | — | 3 | A | A | 3 |
| Example 5 | Liquid D | Agent A | 5 wt % | — | 3 | A | B | 3 |
| Example 6 | Liquid E | Agent A | 5 wt % | — | 3 | A | A | 3 |
| Example 7 | Liquid A | Agent A | 5 wt % | — | 1 | A | A | 5 |
| Example 8 | Liquid A | Agent A | 5 wt % | — | 9 | A | A | 1 |
| Example 9 | Liquid A | Agent B | 5 wt % | — | 3 | A | A | 3 |
| Example 10 | Liquid A | Agent C | 5 wt % | — | 3 | A | A | 3 |
| Example 11 | Liquid A | Agent A | 5 wt % | Isocyanate | 3 | A | A | 3 |
| Example 12 | Liquid B | Agent A | 5 wt % | Carbodiimide | 3 | A | A | 3 |
| Example 13 | Liquid B | Agent A | 5 wt % | Oxazoline | 3 | A | A | 3 |
| Example 14 | Liquid A | Agent A | 30 wt % | Isocyanate | 3 | A | A | 0 |
| Example 15 | Liquid A | Agent A | 10 wt % | Isocyanate | 3 | A | A | 2 |
| Example 16 | Liquid A | Agent A | 50 wt % | — | 3 | B | B | 0 |
| Example 17 | Liquid A | Agent A | 1 wt % | — | 3 | A | A | 8 |
| Comparative | Liquid A | — | — | — | 3 | A | A | 15 |
| Example 1 | | | | | | | | |
| Comparative | Liquid F | Agent A | 5 wt % | Isocyanate | 3 | C | C | 3 |
| Example 2 | | | | | | | | |
| Comparative | Liquid A | Agent A | 5 wt % | — | 0.3 | A | A | 10 |
| Example 3 | | | | | | | | |
| Comparative | Liquid A | Agent A | 5 wt % | — | 15 | A | C | 0 |
| Example 4 | | | | | | | | |

[Reference Signs List] 10, 20, 30, 40 . . . Packaging material for solid-state batteries; 11 . . . Substrate layer; 12a . . . First adhesive layer; 12b . . . Second adhesive layer; 13 . . . Gas barrier layer; 14a . . . First anti-corrosion treatment layer; 14b . . . Second anti-corrosion treatment layer; 15 . . . Adhesive resin layer; 16 . . . Sealant layer; 16a . . . First sealant layer; 16b . . . Second sealant layer; 17 . . . Protective layer; 18 . . . Hydrogen sulfide adsorption layer; 50 . . . Fully-Solid-state battery; 52 . . . Battery element; 53 . . . Metal terminal.

What is claimed is:

1. A packaging material for fully-solid-state batteries, comprising:
at least a substrate layer, a gas barrier layer, a sealant layer, and a hydrogen sulfide adsorption layer,
wherein the hydrogen sulfide adsorption layer contains a modified polyolefin resin and a hydrogen sulfide adsorbent and has a thickness of greater than or equal to 0.5 μm and less than 10 μm.

2. The packaging material for fully-solid-state batteries of claim 1, wherein the hydrogen sulfide adsorption layer is disposed on a surface opposite the gas barrier layer of the sealant layer.

3. The packaging material for all-solid-state batteries of claim 1, wherein the hydrogen sulfide adsorption layer is disposed on a surface on the gas barrier layer side of the sealant layer.

4. The packaging material for fully-solid-state batteries of claim 1, wherein the modified polyolefin resin is an acid-modified polyolefin resin.

5. The packaging material for fully-solid-state batteries of claim 4, wherein the acid-modified polyolefin resin is a maleic anhydride-modified polypropylene resin.

6. The packaging material for fully-solid-state batteries of claim 4, wherein the acid-modified polyolefin resin has an acid value of 2 to 30 mgKOH/g.

7. The packaging material for fully-solid-state batteries of claim 4, wherein the acid-modified polyolefin resin has a melting point of 70 to 150° C.

8. The packaging material for fully-solid-state batteries of claim 1, wherein a content of the hydrogen sulfide adsorbent, relative to a total amount of the hydrogen sulfide adsorption layer, is 1 to 50 mass %.

9. The packaging material for fully-solid-state batteries of claim 1, wherein the hydrogen sulfide adsorption layer further contains at least one selected from the group consisting of an isocyanate compound, a carbodiimide compound, and an oxazoline compound.

10. The packaging material for fully-solid-state batteries of claim 1, wherein the hydrogen sulfide adsorption layer is formed by coating with a coating liquid that contains at least the modified polyolefin resin and the hydrogen sulfide adsorbent.

11. The packaging material for fully-solid-state batteries of claim 1, wherein the hydrogen sulfide adsorption layer has a thickness of less than 5 μm.

12. A solid-state battery comprising:
a battery element that contains a sulfide-based solid electrolyte;
a current-extracting terminal extending from the battery element; and
the packaging material for fully-solid-state batteries of claim 1 which sandwiches the current-extracting terminal and houses the battery element.
